(19) United States
(12) Patent Application Publication
(10) Pub. No.: US 2025/0272597 A1
(43) Pub. Date: Aug. 28, 2025

(54) TRAINING OF LARGE LANGUAGE MODELS USING AUTOMATED REFERENCE AUGMENTATION

(71) Applicant: ServiceNow, Inc., Santa Clara, CA (US)

(72) Inventors: Venkatesh Gunda, Sunnyvale, CA (US); Khalil Slimi, Montreal (CA); Gautam Singaraju, Dublin, CA (US); Rohit Dixit, Fremont, CA (US)

(21) Appl. No.: 18/584,344

(22) Filed: Feb. 22, 2024

(51) Int. Cl. G06N 20/00

(52) U.S. Cl. CPC G06N 20/00

(57) ABSTRACT

A method for automatically providing references to source materials corresponding to generative AI outputs is disclosed. A training data item including source content and a response corresponding to the source content is received. The source content is segmented into a plurality of source content segments, and the response is segmented into a plurality of target segments. At least one entailment pair that includes a target segment included in the plurality of target segments and a source content segment included in the plurality of source content segments is identified. The training data item is annotated using the at least one entailment pair. The annotated training data item is provided to a large language model. The large language model is trained using the annotated training data item.

### BACKGROUND OF THE INVENTION

A Large Language Model (LLM) is a type of artificial intelligence (AI) model designed to understand and generate human-like language. These models are trained on vast amounts of textual data and can perform various natural language processing tasks, such as text completion, question answering, language translation, and text generation.

LLMs may learn statistical relationships from text documents during a computationally intensive self-supervised and semi-supervised training process. Some LLMs are artificial neural networks typically built with a transformer-based architecture. Other alternative architectures include recurrent neural network variants and Mamba (a state space model).

LLMs may be used for text generation, a form of generative AI, by taking an input text and repeatedly predicting the next token or word. One notable example is GPT-3 (Generative Pre-trained Transformer 3), developed by OpenAI.

### BRIEF DESCRIPTION OF THE DRAWINGS

Various embodiments of the invention are disclosed in the following detailed description and the accompanying drawings.

FIG. 1 illustrates an exemplary process 100 for training LLMs.

FIG. 2 illustrates an exemplary process 200 for automatically providing references to source materials corresponding to generative AI outputs.

FIG. 3 illustrates an exemplary system 300 for training data preparation.

FIG. 4 illustrates an exemplary source content 402 and an exemplary corresponding annotated response 404.

FIG. 5 illustrates an exemplary inference system 500 for generating an annotated response of a source content.

FIG. 6 illustrates an exemplary source content 602 and an exemplary corresponding annotated response 604 generated by the large language model.

FIG. 7 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Hallucination and missing details are issues associated with the use of a large language model (LLM). In generative AI models, a hallucination or artificial hallucination is a response generated by an AI that contains false or misleading information presented as fact. In the context of large language models, such as GPT-3, a hallucination might manifest as the model generating information that is fictional, inaccurate, or inconsistent with the input provided.

For previously existing LLMs, there is a lack of visibility regarding how these models operate and generate their outputs. For example, when a model is asked to provide a summary for a document, the model may generate the summary without providing any information as to which part of the source material a particular sentence of the summary is referring to.

It is therefore important to improve the quality and the trustworthiness of LLM model outputs. In the training and fine-tuning of models, hallucinations may be reduced by curating training data and refining the model architecture. It is also important for a model to indicate how the model comes to a conclusion and generates a certain output, given a source material.

In the present application, a method for automatically providing references to source materials corresponding to generative AI outputs is disclosed. A training data item including source content and a response corresponding to the source content is received. The source content is segmented into a plurality of source content segments, and the response is segmented into a plurality of target segments. At least one entailment pair that includes a target segment included in the plurality of target segments and a source content segment included in the plurality of source content segments is identified. The training data item is annotated using the at least one entailment pair. The annotated training data item is provided to a large language model. The large language model is trained using the annotated training data item.

In the present application, the disclosed improved techniques enable a large language model to produce outputs that stay true to the source materials, thereby improving the trustworthiness of the model outputs. The improved techniques allow the model's inference capabilities to be transparently evaluated. For example, the improved techniques provide insights into which specific portions of the source materials that the model has assigned the higher probabilities or weights in generating the model outputs. The improved techniques provide insights into how the model came to a particular conclusion, such that the validity and correctness of the outputs may be verified. This results in significant improvement in quality and transparency.

In some embodiments, annotations are added to the source material and the training data of the model. The model is taught to tag the source material and provide references to the source material corresponding to the generated outputs. By teaching the model to tag references in the source material for the logical constituents of the model output, the model's output is more extractive. In some embodiments, the model may find a reference for every sentence that the model generates. This improves the model output quality significantly. In the training data, references are added to both the context/input & target/output. Fine-tuning of an LLM is performed on this data for the target task, teaching the model to add references to the generated output as a sub-task. The improvements in the model quality significantly reduce the cost of ownership and improve the end user experience. For example, suppose that a live agent is handing over a user request to a second live agent by giving the second live agent a 30-line transcript of the user session that had happened in the past and a corresponding summary. The second agent does not need to look through the 30-line transcript. Instead, the second agent may look at the summary and the cross-references to the specific lines of the 30-line transcript from which the summary is derived from. As a result, the reading time of the second agent may be reduced, thereby improving the end-user's experience.

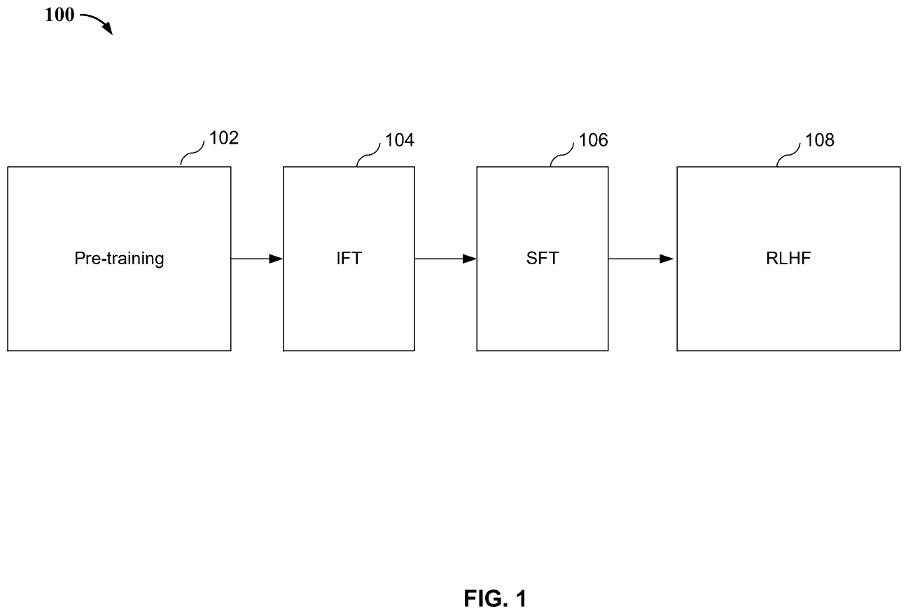

FIG. 1 illustrates an exemplary process 100 for training LLMs. Process 100 includes four phases. The first phase is a pre-training phase 102. Pre-training the language model is typically the most computationally-expensive step of training. The second phase is an instruction fine-tuning (IFT) phase 104, which involves fine-tuning the base model on demonstrations of desired responses or expected behaviors on a diverse set of tasks. These instruction demonstrations are made up of three main components—the instruction/inputs, the context, and the outputs. The context is optional. An input and output when present form an instance. The third phase is a supervised fine-tuning (SFT) phase 106. In SFT phase 106, a dataset of high-quality desired LLM outputs is curated. The dataset includes examples of the expected/correct behavior from an LLM for a given context & input. The model is fine-tuned over these examples. The model learns to replicate the style of these examples during fine-tuning. The fourth phase is a reinforcement learning from human feedback (RLHF) phase 108 or a reinforcement learning with AI feedback (RLAIF) phase 108. In some embodiments, the improved techniques disclosed in the present application may be applied to SFT phase 106. However, the improved techniques may be applied to IFT phase 104 as well.

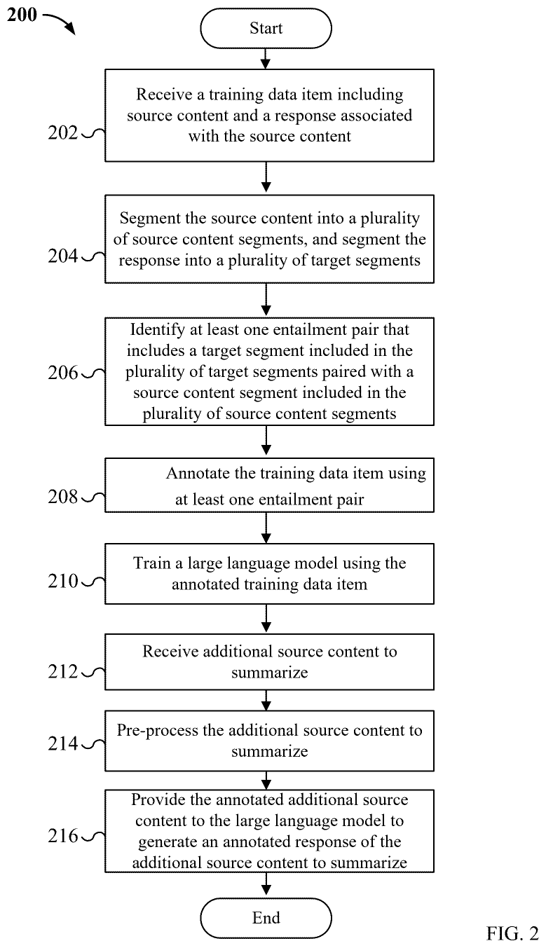

The present application discloses a framework for automatically providing references to source materials corresponding to generative AI outputs, including automated segmentation, automated entailment, positioning of the references, and adding the references to the sources during inference. FIG. 2 illustrates an exemplary process 200 for automatically providing references to source materials corresponding to generative AI outputs. This process is applicable to any task that can benefit from using references, such as high-level question-answering tasks. Summarization is one example of the question-answering tasks, where the question is to summarize a piece of text/document/chat, and the answer/response is the summary.

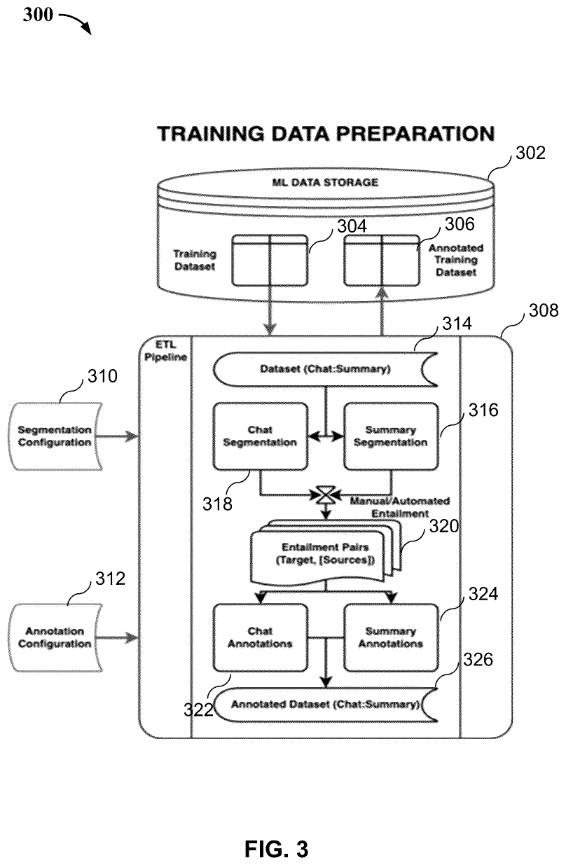

At step 202, a training data item including source content and a response associated with the source content is received. For illustration purposes only, chat summarization is one example use of the improved techniques disclosed in the present application. In this example, the question is to summarize a piece of text/document/chat, and the answer/response is the summary. FIG. 3 illustrates an exemplary system 300 for training data preparation. In some embodiments, at least some of the components in system 300 are used to perform some of the steps in process 200, including steps 202, 204, 206, and 208. System 300 includes a machine learning (ML) data storage 302 for receiving and storing a training dataset 304 and its corresponding annotated training dataset 306. Training dataset 304 includes a plurality of training data items, each including a source content and a response corresponding to the source content. For example, a source content may be a text description, such as a chat transcript, a report, an article, and the like. The response/summary corresponding to the source content comprises a comprehensive and brief abstract of the source content. Training dataset 304 is sent to an extract, transform, load (ETL) pipeline 308. In computing, ETL is a three-phase process where data is extracted, transformed (e.g., cleaned), and loaded into an output data container. ETL pipeline 308 receives training dataset 304 as an input dataset 314 and outputs a corresponding annotated training dataset 326. In some embodiments, ETL pipeline 308 processes training dataset 304 based on different configurations, including segmentation configuration 310 and annotation configuration 312. Annotated training dataset 306 includes a plurality of annotated training data items, each including an annotated source content and an annotated response/summary corresponding to the annotated source content.

At step 204, the source content is segmented into a plurality of source content segments, and the response/summary is segmented into a plurality of target segments. This step may be performed as part of the automated segmentation portion of the framework. The source content may be referred to as the context and the response/summary may be referred to as the target. The source content is segmented into logical constituents or segments. For example, a chat transcript may be segmented by a source/chat segmentation module 318. Similarly, the response/summary is segmented into target segments by a response/summary segmentation module 316.

A logical constituent is a semantically homogeneous unit that makes a single point. A logical constituent may be defined based on the type of the source, which may be specified in segmentation configuration 310. For example, if the source type is a chat transcript, then each chat message may be a logical constituent. In a service note case, a comment or a work note may be a different constituent. In some embodiments, a logical constituent may be a sentence or a paragraph. For example, if the logical constituent is a sentence, then a new segment may be obtained whenever a period is detected in the source content. In other examples, a new segment may be obtained whenever a comma or a phrase is detected in the source content. The logical constituents of the source and the target may be different. A logical constituent may be defined based on the data type, including structured data types (e.g., JavaScript Object Notation (JSON), Extensible Markup Language (XML), and Hyper Text Markup Language (HTML)) and unstructured data types (e.g., short text, long-form text, and keywords.). A mechanism may be formulated to uniquely identify each constituent in the source content (or the target content) and divide it into a plurality of segments. This may be automated through a deterministic rulebook, or through a probabilistic model.

In some embodiments, the source content is a chat transcript, and regular expressions may be used to annotate the transcript and divide the transcript into the individual messages. For example, the line numbers, timestamps, and speaker labels may be used as the identifiers. In some embodiments, the summary (i.e., the target) may be divided into segments using commas. For example, “the dog was barking at the cat, and the cat was chasing the mouse” is divided into two segments. Additional logic may be added to interpret that comma separated items/lists are not identified as separate phrases/segments. For example, “cat, dog, horse” is not divided into three separate segments.

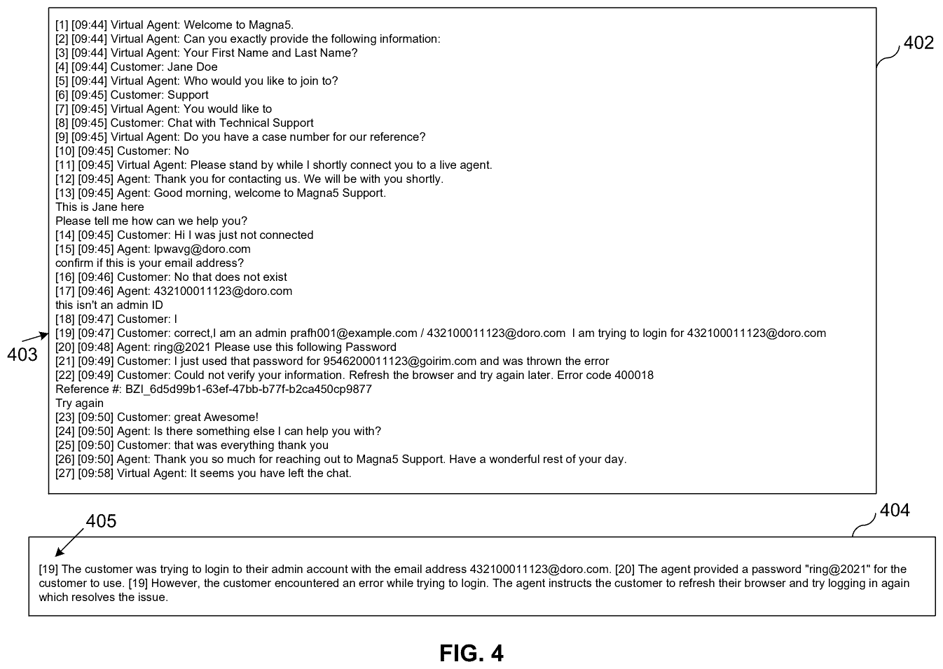

FIG. 4 illustrates an exemplary source content 402 and an exemplary corresponding annotated response 404. Source content 402 is an annotated chat transcript of a chat between a virtual agent and a customer. In this example, a source content segment 403 is identified by a line number 19 (denoted as “[19]”), a timestamp, and a speaker label.

At step 206, at least one entailment pair that includes a target segment included in the plurality of target segments paired with a source content segment included in the plurality of source content segments is identified. This step may be performed as part of the automated entailment portion of the framework.

An entailment pair refers to a pair of sentences where one sentence logically follows or is entailed by the other. The relation holds whenever the truth of one text fragment follows from another text. For example, a premise “The cat is sitting on the mat” and a hypothesis “A pet is resting on the rug” form an entailment pair. In this example, the premise entails or implies the hypothesis, as the concept of a cat sitting on a mat is similar to a pet resting on a rug. Entailment pairs are often used in training and evaluating LLMs to assess their ability to understand and reason about the relationships between sentences. At step 206, a source content segment is found to entail a target segment.

Entailment scores may be computed to determine one or more ground truth references to the source from the target. Entailment scores are used to quantify the level of semantic similarity or entailment between pairs of text. An entailment score is used to determine whether one text (the hypothesis) logically follows from another text (the premise). The score indicates how strongly the hypothesis is entailed by the premise. For instance, if the entailment score is high, it suggests a strong logical relationship between the premise and the hypothesis, indicating that the hypothesis can be inferred or logically derived from the premise. Conversely, a low entailment score suggests weak or no logical entailment between the two sentences. In other words, an entailment score is a numerical value assigned to indicate the degree of logical entailment between two linguistic expressions, such as sentences or phrases. For example, given a source content segment A, an entailment score may indicate the confidence of a target segment statement B being True/False. Entailment scores may be computed using various techniques, including neural network models, similarity measures, or other methods designed to capture the semantic relationship between texts. The type of entailment score may either be extractive or semantic. For the extractive type, a map between the source and the target is created based on keywords. For the semantic type, a map between the source and the target is created based on the meanings of the words. In some embodiments, a weighted (learned) average of both types of scores may be used.

For each source-response constituent pair, an entailment score is computed. For each target segment, the top-N scoring source content segments with scores above a learned/predetermined threshold are selected as the references. These are the identified source content segments that are used to infer the target segment. Suppose that N=3, then a target segment may have up to three references to the source. These relationships are represented by three entailment pairs, which may be stored in an entailment pairs database 320. The first entailment pair includes source content segment #1 paired with the target segment; the second entailment pair includes source content segment #2 paired with the target segment; and the third entailment pair includes source content segment #3 paired with the target segment.

Both human-annotated data and model-annotated data may be used. For the model-annotated data, an open-source implementation of an algorithm known as Recall-Oriented Understudy for Gisting Evaluation (ROUGE) may be used to compute the entailment scores, rank, and select the top-3 references above a predetermined threshold (e.g., 0.3).

At step 208, the training data item is annotated using at least one entailment pair. This step may be performed as part of the framework for positioning the references. After the entailment pairs are found at step 206 above, the training data item is annotated using the entailment pairs. For example, to form the annotated response, each target segment may be annotated to indicate the one or more associated source content segments corresponding to the target segment's associated entailment pairs. The response annotations may be determined by response/summary annotations module 324. In some embodiments, the position of the annotation/reference for a target segment is one adjacent to the target segment, such as the beginning of the target segment. The annotation/reference is a prefix to the target segment. Adding the references at the beginning of the constituent, as opposed to adding the references at the end, has certain benefits. As LLMs are regressive, they look back at the previous output while generating the current token. As a result, a prefix reference serves as a lookup for the model and helps improve the probabilities of staying true to the reference statement. By putting the references at the start of the sentence, the model is trained to use the references it cited for the rest of the sentence, improving the output quality. For example, as shown in FIG. 4, at the beginning of the target segment “The customer was trying to login to their admin account with the email address 432100011123@doro.com” is an annotation 405 indicating that line number 19 of source content 402 is the source for inferring the target segment.

However, in other embodiments, the position of the annotation/reference for a target segment may be the end of the target segment as well. The annotation/reference is a suffix to the target segment.

To form the annotated chat/source content, each source content segment may also be annotated to indicate the target segment that corresponds to the source content segment's associated entailment pair. The source annotations may be determined by chat annotations module 322. ETL pipeline 308 outputs annotated training dataset 326, which includes a plurality of annotated training data items, each including an annotated source content and an annotated response corresponding to the annotated source content.

At step 210, a large language machine learning model is trained using the annotated training data item. For example, the annotated training dataset 306 stored in machine learning (ML) data storage 302 is provided to an LLM model for training the LLM model. The model is trained to do a task of summarization of the source content with a sub-task to provide self-referencing. The self-referencing task includes the generation of references/annotations that are embedded in the response generated by the model.

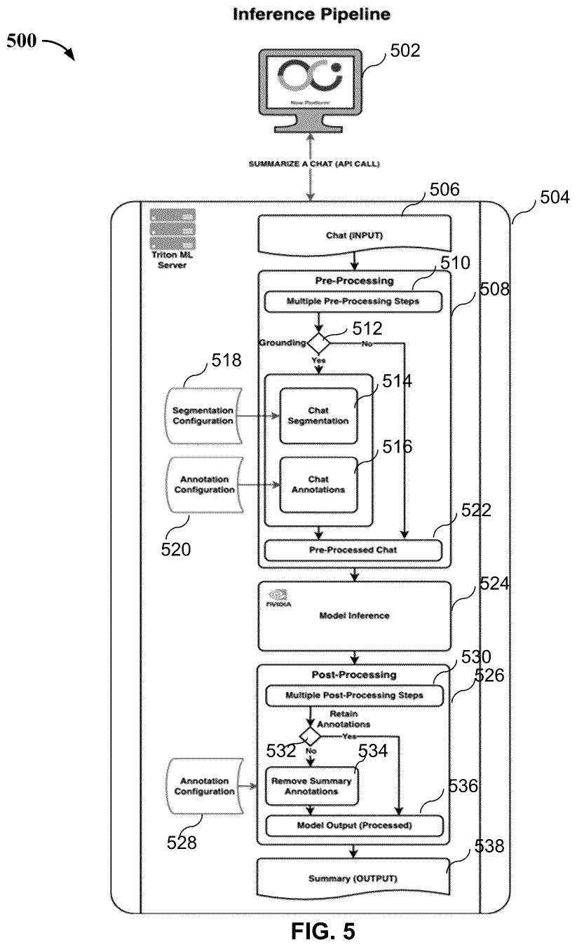

At step 212, additional source content to summarize is received. For example, the additional source content may be a text description, such as a chat transcript, a report, an article, and the like. FIG. 5 illustrates an exemplary inference system 500 for generating an annotated response of a source content. In some embodiments, at least some of the components in system 500 are used to perform some of the steps in process 200, including steps 212, 214, and 216. Inference pipeline 504 receives a source content input 506 from a graphical user interface (GUI) 502 via an application programming interface (API) call.

At step 214, the additional source content is pre-processed by a pre-processing module 508. Source content input 506 is pre-processed by a first-stage pre-processing module 510 that performs multiple pre-processing steps. If annotation (also referred to as grounding) of the response is enabled at 512, then the source content is segmented into logical segments and annotated. For example, an input chat transcript may be segmented by a chat segmentation module 514 based on a segmentation configuration 518 and annotated by a chat annotation module 516 based on an annotation configuration 520. Chat annotation module 516 may add annotations to each message, including line numbers, timestamps, and speaker labels. A pre-processed chat 522 is an output of pre-processing module 508.

At step 216, the additional source content that has been pre-processed is provided to a large language machine learning model 524 to generate an annotated response/summary of the additional source content. Large language machine learning model 524 is the model that was trained to do a task of summarization of the source content with a sub-task to provide self-referencing, as described in step 210 above.

The annotated response output of large language machine learning model 524 is then processed by a post-processing module 526. The annotated response/summary output is post-processed by a first-stage post-processing module 530 that performs multiple post-processing steps. If annotation of the response is enabled at 532 based on annotation configuration 528, then the annotated response output forms the post-processed output 536, which forms the final response output 538. Otherwise, the annotations in the response are removed by module 534 to form the post-processed output 536, which forms the final response/summary output 538.

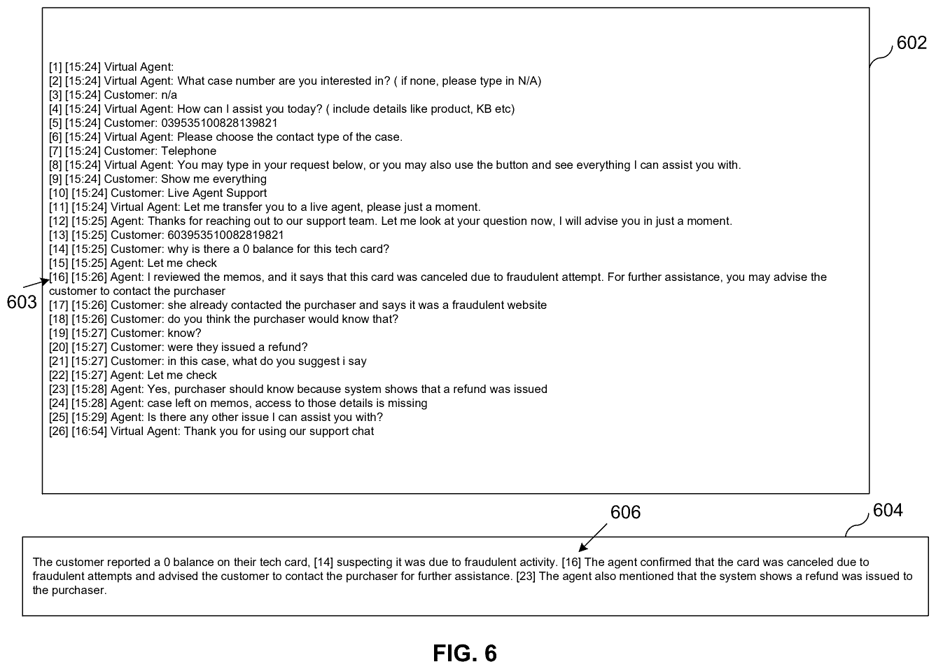

FIG. 6 illustrates an exemplary source content 602 and an exemplary corresponding annotated response 604 generated by the large language model. The target segment “The agent confirmed that the card was canceled due to fraudulent attempts and advised the customer to contact the purchaser for further assistance” has an annotation 606 indicating that line number 16 is the location of source content segment 603 for inferring the target segment.

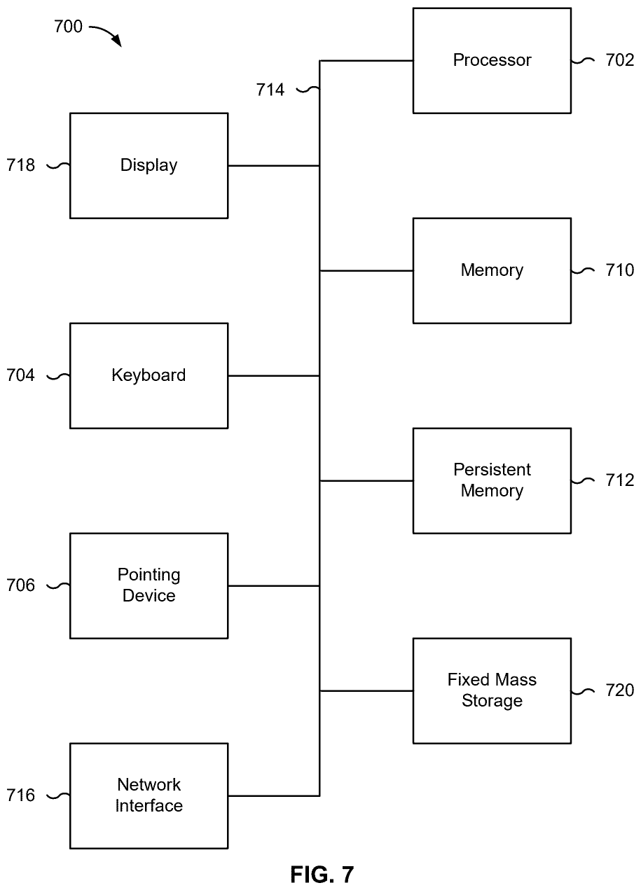

FIG. 7 is a functional diagram illustrating a programmed computer system. In some embodiments, process 200 in FIG. 2 is executed by computer system 700. Computer system 700 is an example of a processor.

In the example shown, computer system 700 includes various subsystems as described below. Computer system 700 includes at least one microprocessor subsystem (also referred to as a processor or a central processing unit (CPU)) 702. Computer system 700 can be physical or virtual (e.g., a virtual machine). For example, processor 702 can be implemented by a single-chip processor or by multiple processors. In some embodiments, processor 702 is a general-purpose digital processor that controls the operation of computer system 700. Using instructions retrieved from memory 710, processor 702 controls the reception and manipulation of input data, and the output and display of data on output devices (e.g., display 718).

Processor 702 is coupled bi-directionally with memory 710, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also, as is well known in the art, primary storage typically includes basic operating instructions, program code, data, and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown).

Persistent memory 712 (e.g., a removable mass storage device) provides additional data storage capacity for computer system 700, and is coupled either bi-directionally (read/write) or uni-directionally (read only) to processor 702. For example, persistent memory 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of fixed mass storage 720 is a hard disk drive. Persistent memory 712 and fixed mass storage 720 generally store additional programming instructions, data, and the like that typically are not in active use by the processor 702. It will be appreciated that the information retained within persistent memory 712 and fixed mass storages 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, pointing device 706 can be a mouse, stylus, track ball, or tablet, and is useful for interacting with a graphical user interface.

Network interface 716 allows processor 702 to be coupled to another computer, computer network, or telecommunications network using a network connection as shown. For example, through network interface 716, processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect computer system 700 to an external network and transfer data according to standard protocols. Processes can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a training data item including source content and a response associated with the source content;
segmenting the source content into a plurality of source content segments, and segmenting the response into a plurality of target segments;
identifying at least one entailment pair that includes a target segment included in the plurality of target segments and a source content segment included in the plurality of source content segments;
annotating the training data item using the at least one entailment pair; and
providing the annotated training data item to a large language model.

2. The method of claim 1, further comprising:
training the large language model using the annotated training data item.

3. The method of claim 1, further comprising:
determining an entailment score associated with the at least one entailment pair, wherein the entailment score comprises a numerical value indicating a degree of entailment; and
determining the at least one entailment pair by at least comparing the entailment score to entailment scores associated with other entailment pairs and comparing the entailment score to a predetermined entailment score threshold.

4. The method of claim 1, further comprising:
annotating the response corresponding to the source content by including a reference to the source content segment of the at least one entailment pair, wherein the reference is positioned adjacent to the target segment of the at least one entailment pair.

5. The method of claim 4, wherein the reference is positioned at a beginning of the target segment of the at least one entailment pair.

6. The method of claim 1, wherein annotating the training data item comprises using one or more of the following: a line number, a timestamp, or a speaker label.

7. The method of claim 1, further comprising:
training the large language model to generate a new response for additional source content and generate at least one reference embedded in the new response, wherein the at least one reference refers to at least one portion of the additional source content.

8. The method of claim 1, further comprising:
receiving additional source content to summarize;
annotating the additional source content to summarize; and
providing the annotated additional source content to the large language model to generate an annotated response of the additional source content to summarize.

9. The method of claim 1, wherein the source content comprises text content, and the method further comprising:
segmenting the source content into the plurality of source content segments by segmenting the source content into one or more of the following: a plurality of sentences or a plurality of paragraphs.

10. The method of claim 1, wherein the source content comprises a chat transcript, and the method further comprising:
segmenting the source content into the plurality of source content segments by segmenting the source content into a plurality of chat messages.

11. The method of claim 1, further comprising:
segmenting the source content into the plurality of source content segments based on a source content type.

12. A system, comprising:
a processor configured to:
receive a training data item including source content and a response associated with the source content;
segment the source content into a plurality of source content segments, and segment the response into a plurality of target segments;
identify at least one entailment pair that includes a target segment included in the plurality of target segments and a source content segment included in the plurality of source content segments;
annotate the training data item using the at least one entailment pair; and
provide the annotated training data item to a large language model; and
a memory coupled to the processor and configured to provide the processor with instructions.

13. The system of claim 12, wherein the processor is configured to:
train the large language model using the annotated training data item.

14. The system of claim 12, wherein the processor is configured to:
determine an entailment score associated with the at least one entailment pair, wherein the entailment score comprises a numerical value indicating a degree of entailment; and
determine the at least one entailment pair by at least comparing the entailment score to entailment scores associated with other entailment pairs and comparing the entailment score to a predetermined entailment score threshold.

15. The system of claim 12, wherein the processor is configured to:
annotate the response corresponding to the source content by including a reference to the source content segment of the at least one entailment pair, wherein the reference is positioned adjacent to the target segment of the at least one entailment pair.

16. The system of claim 15, wherein the reference is positioned at a beginning of the target segment of the at least one entailment pair.

17. The system of claim 12, wherein annotating the training data item comprises using one or more of the following: a line number, a timestamp, or a speaker label.

18. The system of claim 12, wherein the processor is configured to:
train the large language model to generate a new response for additional source content and generate at least one reference embedded in the new response, wherein the at least one reference refers to at least one portion of the additional source content.

19. The system of claim 12, wherein the processor is configured to:
receive additional source content to summarize;
annotate the additional source content to summarize; and
provide the annotated additional source content to the large language model to generate an annotated response of the additional source content to summarize.

20. A computer program product embodied in a non-transitory computer readable medium and comprising computer instructions for:
receiving a training data item including source content and a response associated with the source content;
segmenting the source content into a plurality of source content segments, and segmenting the response into a plurality of target segments;
identifying at least one entailment pair that includes a target segment included in the plurality of target segments and a source content segment included in the plurality of source content segments;
annotating the training data item using the at least one entailment pair; and
providing the annotated training data item to a large language model.
